(19) United States
(12) Patent Application Publication
(10) Pub. No.: US 2026/0135286 A1
(43) Pub. Date: May 14, 2026

(54) ADJUSTABLE STRUCTURE FOR ANTENNA MOUNTING BRACKET

(71) Applicant: Xue-Feng Chen, Guangzhou City (CN)

(72) Inventor: Xue-Feng Chen, Guangzhou City (CN)

(21) Appl. No.: 18/946,891

(22) Filed: Nov. 13, 2024

(51) Int. Cl. H01Q 1/12

(52) U.S. Cl. CPC H01Q 1/1221; H01Q 1/1228

(57) ABSTRACT

The present invention relates to an adjustable structure for an antenna mounting bracket, which includes: a first arm with a plurality of first positioning holes at one end; a second arm, with an arm-facing end as one end and a wall-facing end as the other end, the arm-facing end having a plurality of second positioning holes, and at least three pairs of the first positioning holes and the second positioning holes corresponding to each other; a plurality of first fixing pins, respectively inserted into the plurality of first positioning holes and the plurality of second positioning holes corresponding to each other; and a wall-mounting component, connected to the wall-facing end of the second arm.

### BACKGROUND OF THE INVENTION

### Fields of the Invention

The present invention relates to an adjustable structure for an antenna mounting bracket, used to assist in the installation of an antenna dish in a router system.

### Descriptions of Related Art

Routers are widely used in households to provide network signals, and some models have the function of enhancing signals. To provide internet access, routers need to be paired with other equipment to form a complete system. Taking the Starlink router as an example, it includes an antenna dish, a main unit, and a power supply. The main unit connects the antenna dish to the power supply. The advantage is that, regardless of the user's location, as long as the antenna dish is not obstructed, the user can obtain stable internet speeds at any time.

When setting up a Starlink router, the antenna dish is usually installed outdoors (such as on the roof of a house) and should remain unobstructed. The main unit and power supply can be installed indoors. A common method for installing the antenna dish is to use a bracket to fix it to the roof. However, the existing brackets on the market only provide support and have some shortcomings. In fact, there is an optimal reception angle for an antenna dish, but not every installation location has the same conditions, such as differences in roof shape or slope. As a result, when the bracket is used to install the antenna dish in a target location, the reception angle of the antenna dish is often less than ideal, leading to reduced system performance.

In view of the above-mentioned issues, it is evident that the current brackets for antenna dishes on the market have the problem of poor reception angles during installation.

### SUMMARY OF THE INVENTION

The present invention aims to address conventional problems by providing a structure that includes a first arm and a second arm. The first arm and the second arm are provided with first positioning holes and second positioning holes, respectively. During use, the first arm can be pivoted relative to the second arm until at least three of the first positioning holes correspond to at least three of the second positioning holes, after which first fixing pins can be inserted to secure them. Accordingly, the angle between the first arm and the second arm can be changed. As such, a wall-mounting component connected to the second arm can be installed on a wall or roof, while the first arm is connected to an antenna dish mounting seat, providing various angle settings. This improves the issue of poor reception angles when mounting antenna dishes with current brackets on the market. The present invention demonstrates novelty and inventive step.

To achieve the above effects and objectives, the present invention provides an adjustable structure for an antenna mounting bracket, which includes: a first arm, with a plurality of first positioning holes at one end thereof; a second arm, with an arm-facing end as one end and a wall-facing end as the other end, the arm-facing end having a plurality of second positioning holes, and at least three of the first positioning holes corresponding to at least three of the second positioning holes; a plurality of first fixing pins, respectively inserted into the plurality of first positioning holes and the plurality of second positioning holes corresponding to each other; and a wall-mounting component, connected to the wall-facing end of the second arm.

Further, the first arm and the second arm are hollow.

Further, the wall-mounting component has an arc-shaped guide rail, and a connecting part passes through the arc-shaped guide rail and the wall-facing end.

Further, the wall-facing end of the second arm has a plurality of third positioning holes; the wall-mounting component has a plurality of fourth positioning holes; at least two of the plurality of third positioning holes correspond to at least two of the plurality of fourth positioning holes; and a plurality of second fixing pins are inserted into the plurality of third positioning holes and the plurality of fourth positioning holes corresponding to each other.

Further, an angle between the first arm and the second arm is 90 degrees.

Further, an angle between the first arm and the second arm is 135 degrees.

Further, an angle between the first arm and the second arm is 180 degrees.

### BRIEF DESCRIPTION OF THE DRAWINGS

FIG. 1 is a perspective schematic view of the present invention.

FIG. 2 is an exploded schematic view of the present invention.

FIG. 2A is an exploded view from another angle of the present invention.

FIG. 3 is an application schematic view of the present invention.

FIG. 4 is a cross-sectional schematic view taken along line IV-IV of FIG. 1.

FIG. 5 is a cross-sectional schematic view taken along line V-V of FIG. 1.

FIG. 6 is a schematic view showing the angle between the first arm and the second arm as 90 degrees.

FIG. 7 is a schematic view showing the angle between the first arm and the second arm as 135 degrees.

FIG. 8 is a schematic view showing the angle between the first arm and the second arm as 180 degrees.

### DETAILED DESCRIPTION OF THE PREFERRED EMBODIMENT

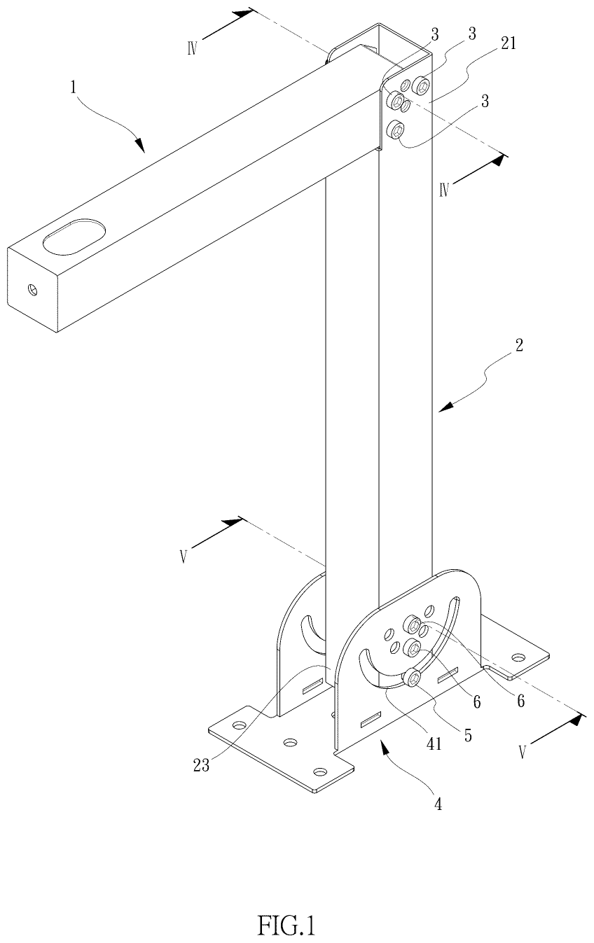

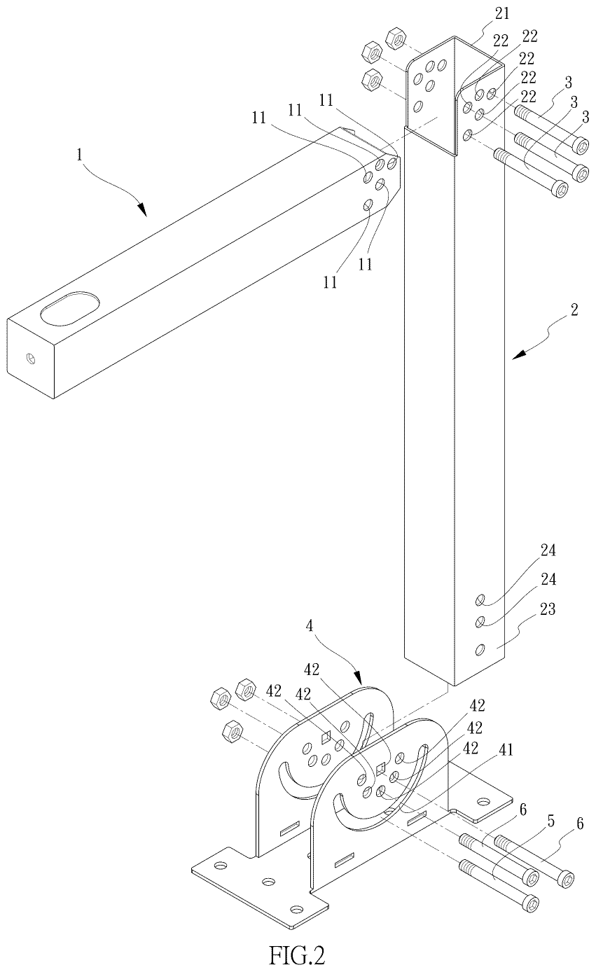

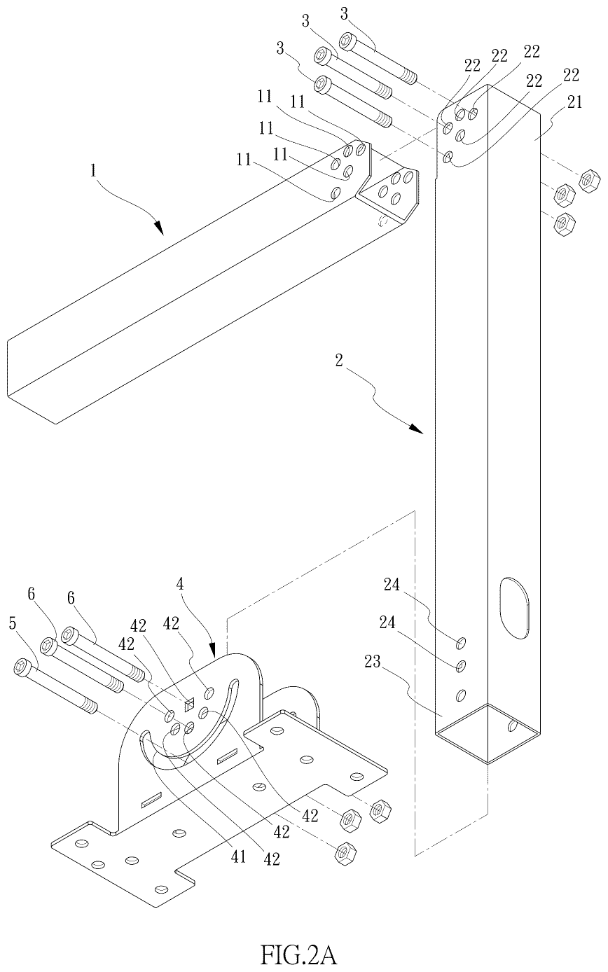

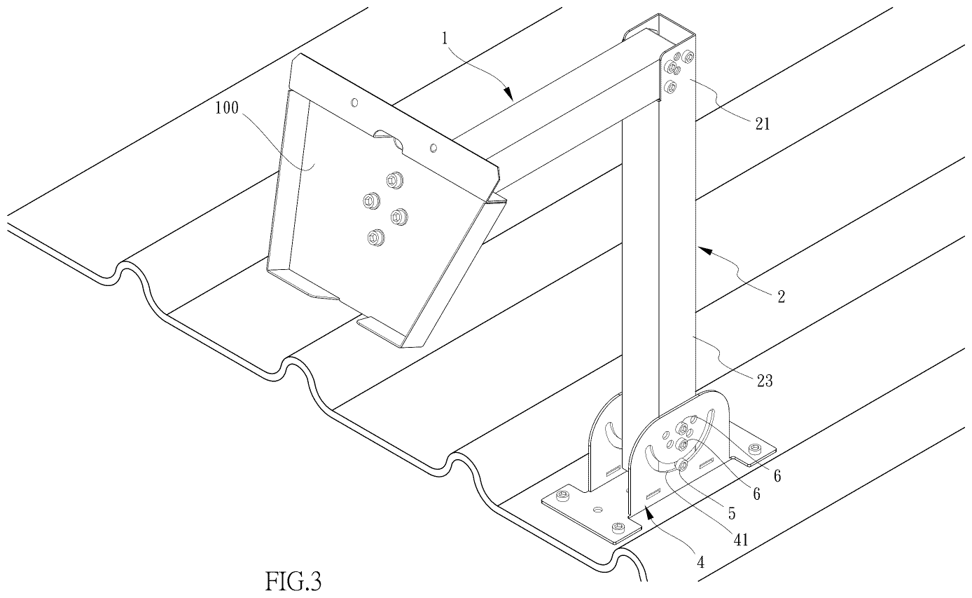

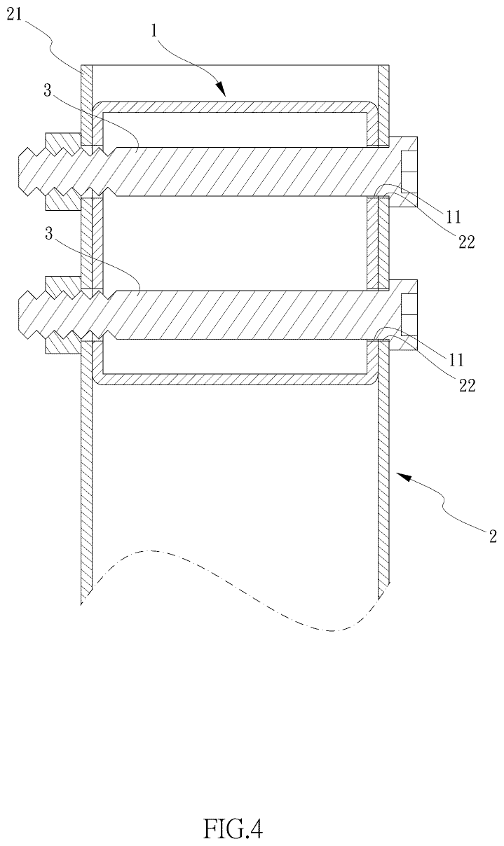

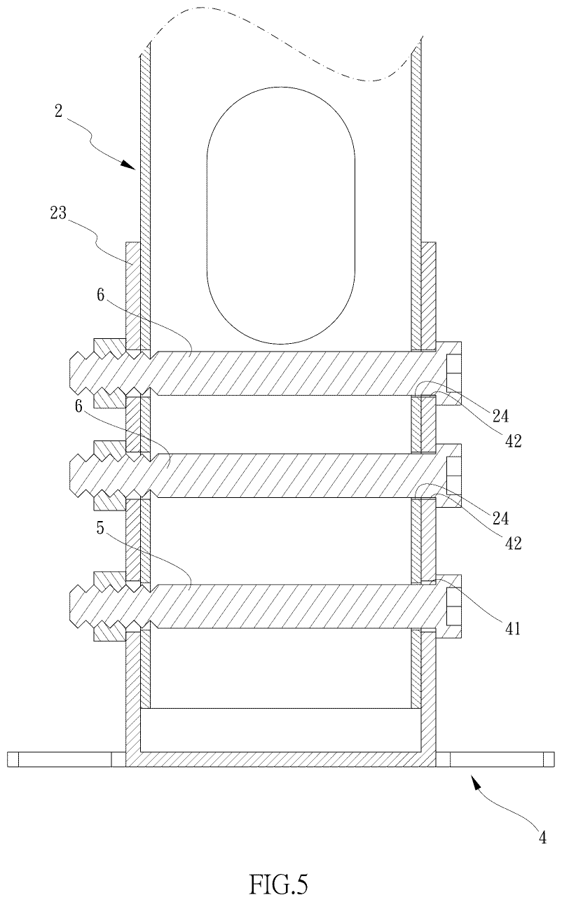

For more detailed understanding of embodiments of the present invention, please refer to the accompanying figures. As shown in FIGS. 1 to 5, an adjustable structure for an antenna mounting bracket includes: a first arm 1, with a plurality of first positioning holes 11 at one end; a second arm 2, with an arm-facing end 21 as one end and a wall-facing end 23 as the other end, the arm-facing end 21 having a plurality of second positioning holes 22, and at least three pairs of the first positioning holes 11 and the second positioning holes 22 corresponding to each other; a plurality of first fixing pins 3 (for example, in this embodiment, if there are three corresponding hole pairs, then three fixing pins 3 are used, and these three fixing pins 3 form a triangular positioning structure with superior support), respectively inserted into the plurality of first positioning holes 11 and the plurality of second positioning holes 22 corresponding to each other; and a wall-mounting component 4 (referring to FIG. 4, which shows a cross-sectional schematic view where two fixing pins 3 are inserted), connected to the wall-facing end 23 of the second arm 2.

The main technical features of the primary embodiment of the present invention correspond to the content of claim 1 in the patent application, providing a complete understanding of the purposes and implementations of the present invention. The technical features recited in remaining dependent claims are additional or supplementary technical features in addition to those in claim 1 and are not intended to limit the scope of claim 1. It should be understood that claim 1 does not necessarily include the technical features of the other dependent claims.

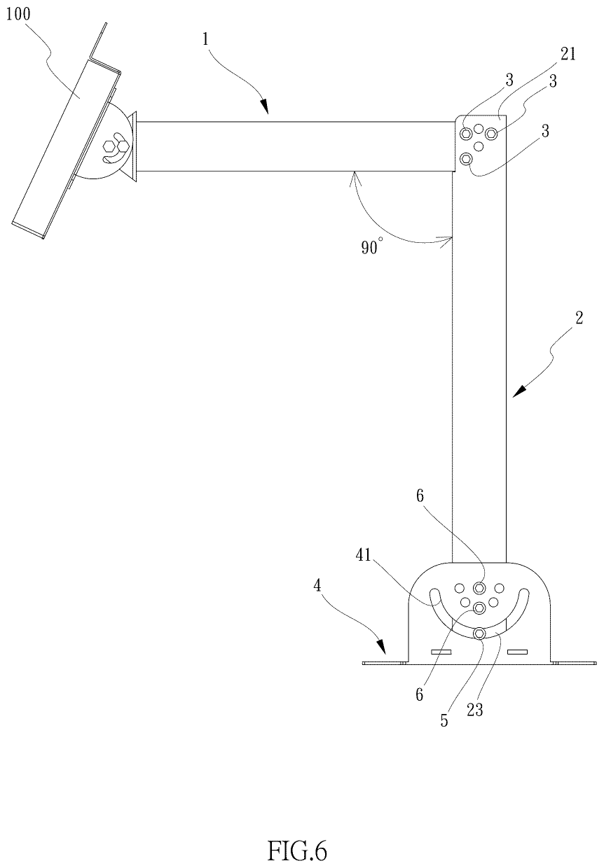

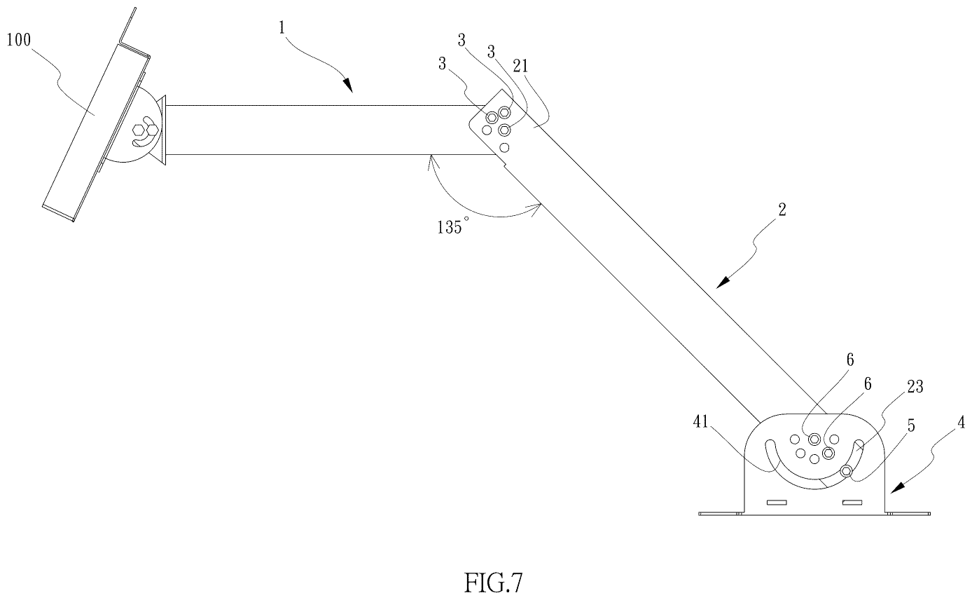

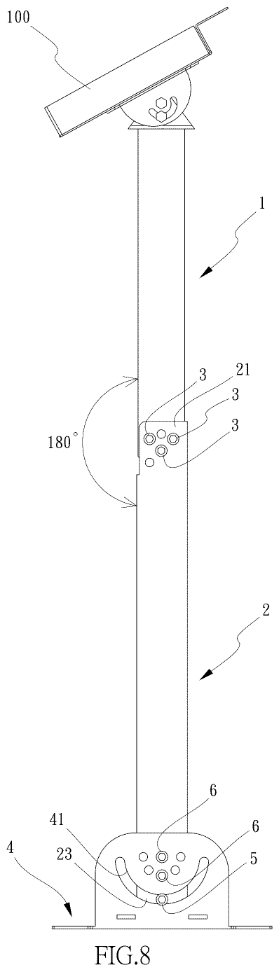

Continuing from the above, a further detailed description of the embodiment is provided. The present invention addresses conventional problems by providing a structure that includes a first arm 1 and a second arm 2. The first arm 1 and the second arm 2 are provided with first positioning holes 11 and second positioning holes 22, respectively. During use, the first arm 1 can be pivoted relative to the second arm 2 until any three pairs of the first positioning holes 11 and second positioning holes 22 correspond to each other, followed by inserting the first fixing pins 3 to secure them. Accordingly, the angle between the first arm 1 and the second arm 2 can be changed. As shown in FIGS. 6 to 8, the angle can be 90 degrees, 135 degrees or 180 degrees. As such, the wall-mounting component 4 connected to the second arm 2 can be installed on a wall or roof, while the first arm 1 is connected to the antenna dish mounting seat 100, providing various angle settings. This improves the issue of poor reception angles when mounting antenna dishes with current brackets on the market. The present invention demonstrates novelty and inventive step.

Further, the first arm 1 and second arm 2 are hollow, which allows the wiring connecting the antenna dish to the main unit to be hidden.

Further, the wall-mounting component 4 has an arc-shaped guide rail 41, and a connecting member 5 passes through the arc-shaped guide rail 41 and the wall-facing end 23. The wall-facing end of the second arm 2 has a plurality of third positioning holes 24, and the wall-mounting component 4 has a plurality of fourth positioning holes 42. At least two pairs of the plurality of third positioning holes 24 and the plurality of fourth positioning holes 42 correspond to each other, and a plurality of second fixing pins 6 are inserted into the plurality of third positioning holes 24 and the plurality of fourth positioning holes 42 corresponding to each other. This structure allows the second arm 2 to adjust its angle relative to the wall-mounting component 4, enabling more varied angle adjustments in the present invention.

What is claimed is:

1. An adjustable structure for an antenna mounting bracket, comprising:
a first arm, with a plurality of first positioning holes at one end thereof;
a second arm, with an arm-facing end as one end and a wall-facing end as the other end, the arm-facing end having a plurality of second positioning holes, and at least three of the plurality of first positioning holes corresponding to at least three of the plurality of the second positioning holes;
a plurality of first fixing pins, respectively inserted into the plurality of first positioning holes and the plurality of second positioning holes corresponding to each other; and
a wall-mounting component, connected to the wall-facing end of the second arm.

2. The adjustable structure for an antenna mounting bracket as claimed in claim 1, wherein the first arm and second arm are hollow.

3. The adjustable structure for an antenna mounting bracket as claimed in claim 1, wherein the wall-mounting component has an arc-shaped guide rail, and a connecting member passes through the arc-shaped guide rail and the wall-facing end.

4. The adjustable structure for an antenna mounting bracket as claimed in claim 1, wherein the wall-facing end of the second arm has a plurality of third positioning holes; the wall-mounting component has a plurality of fourth positioning holes; at least two of the plurality of third positioning holes correspond to at least two of the plurality of fourth positioning holes; and a plurality of second fixing pins are inserted into the plurality of third positioning holes and the plurality of fourth positioning holes corresponding to each other.

5. The adjustable structure for an antenna mounting bracket as claimed in claim 1, wherein an angle between the first arm and the second arm is 90 degrees.

6. The adjustable structure for an antenna mounting bracket as claimed in claim 1, wherein an angle between the first arm and the second arm is 135 degrees.

7. The adjustable structure for an antenna mounting bracket as claimed in claim 1, wherein an angle between the first arm and the second arm is 180 degrees.
